(19) United States
(12) Patent Application Publication
(10) Pub. No.: US 2008/0154493 A1
(43) Pub. Date: Jun. 26, 2008

(54) DISTANCE ESTIMATION METHOD FOR A MOVING OBJECT HAVING A CONSTRAINED VERTICAL PATH PROFILE

(75) Inventors: Elias Bitar, Tournefeuille (FR); Pierre Gamet, Blagnac (FR); Nicolas Marty, Saint Sauveur (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 11/963,753

(22) Filed: Dec. 21, 2007

(30) Foreign Application Priority Data
Dec. 21, 2006 (FR) 06 11208

(51) Int. Cl. G01C 21/00

(52) U.S. Cl. 701/208

(57) ABSTRACT

This method makes it possible to plot, from a terrain elevation database, a map of the distances of the points accessible to a moving object subject to constraints (inaccessible reliefs, unnegotiable obstacles, weather disturbances, path with an imposed vertical profile, etc.), the distances being measured only along paths that are practical for the moving object. It employs a chamfer distance transform applied to the image consisting of the projection on the horizontal plane of a 3D representation of the flying space of the moving object, which is likened to a mesh of elementary cubes associated with specific negotiation danger levels. It lists the typical paths without exceeding an acceptable danger threshold, going from a target point, the distance of which is to be estimated, to a source point, the origin of the distance measurements, and likens the distance of the target point to the length of the shortest practicable path or paths.

### RELATED APPLICATIONS

The present application is based on, and claims priority from, French Application Number 06 11208, filed Dec. 21, 2006, the disclosure of which is hereby incorporated by reference herein in its entirety.

### FIELD OF THE INVENTION

The invention relates to the navigation of a moving object, the path of which is subject to vertical profile constraints, in a flying space having locally various danger levels. The moving object may be an aircraft, for example one limited in terms of rate of ascent, the limit possibly being negative, varying above reliefs and/or obstacles on the ground in a zone affected by local weather disturbances close to or above its flight altitude.

### BACKGROUND OF THE INVENTION

Various systems have been developed for warning the crew of an aircraft of a risk of collision with the ground. Some of these, such as terrain awareness and warning systems (TAWS), make a short-term path prediction for the aircraft on the basis of flight information (position, bearing, orientation and amplitude of the velocity vector, etc.) that are provided by the onboard equipment, place it in a situation relative to a map of the overflown region extracted from a terrain elevation database accessible on board, and issue alarms of the risk of collision with the ground to the crew of the aircraft each time the short-term predicted path would come into collision with the ground. These TAWS systems complement their alarms with rudimentary recommendations of the “pull up, avoid terrain” kind. Some of these systems also give information about the nature of the collision risks that the reliefs and obstacles around the aircraft pose in the form of a map produced from a model of the overflown terrain taken from a database of the elevations of the terrain with a regular meshing of the land surface or of part of the latter, presenting the reliefs or the obstacles of the overflown terrain as strata of different colours: red when they cannot be avoided from above, yellow when they can be avoided from above at the cost of a timely manoeuvre being undertaken, and green when they are non-menacing. However, this map of the risks of collision with the environment, although showing the essential vertical and lateral avoidance manoeuvres to be carried out, does not allow the crew of an aircraft to know if, taking into account an avoidance manoeuvre and the flight performance of the aircraft, the next required point of passage of its flight plan or its destination terrain remains accessible to it.

Other systems have been developed for assisting the crew of an aircraft in its appreciation of the weather conditions. Some of these, such as WxR (weather x-radar) systems, generate a map of the dangers presented by the weather on the basis of moisture density measurements made by a radar probing the space lying in front of the aircraft, as points distributed within a mesh consisting of elementary cubes identified by geographical coordinates (latitude, longitude and altitude). This map, which shows the weather risks associated with the elementary cubes of the space located in front of the aircraft, also relies on a model of the overflown terrain taken from a database of the elevations of the terrain, in order to reveal, under a maximum risk level, independent of the radar measurements, the elementary cubes of the representation of the space in front of the aircraft, intercepting the overflown terrain. However, this map of the weather risks, although showing the essential vertical and lateral avoidance manoeuvres to be carried out, also does not allow the crew of an aircraft to know if, taking into account an avoidance manoeuvre and the flight performance of the aircraft, the next acquired point of passage of its flight path or its destination terrain remains accessible to it.

To meet this requirement of knowing points of the overflown terrain that remain accessible after a manoeuvre to avoid a relief or a ground obstacle or a weather perturbation, a map of the weather risks and/or the risks of colliding with the environment must display the minimum distances, taking into account the path constraints experienced by the moving object. Such a display is constructed by associating a metric with a map of the relief taken from a terrain elevation database.

One known method, described by the Applicant, especially in U.S. Patent Application US 2007031007, for associating, with a map of the relief taken from a terrain elevation database, a metric adapted to a moving object subject to vertical path profile constraints consists in considering the map as an image, the pixels of which are the altitude values of the mesh points of the terrain elevation database and in making use, for estimating the distances within this image, of a distance transform operating by propagation and taking into account the constraints (relief, ground obstacles, prohibited overflight zones, imposed vertical path profile, etc.).

The distance transforms operating by propagation, also known as “chamfer distance transforms” or “chamfer Euclidean distance transforms”, deduce the distance from one pixel, called the target pixel, to another pixel, called the source pixel, from the distances previously estimated for the pixels in its vicinity, by scanning the pixels of the image. The scanning makes it possible to estimate the distance of a new target pixel from the source pixel by seeking the path of minimum length going from the new target pixel to the source pixel passing through an intermediate pixel in its vicinity, the distance of which has already been estimated, the distance from the new target pixel to an intermediate pixel in its vicinity, the distance of which has already been estimated, being given by applying what is commonly referred to as a “chamfer mask”. For further details about distance transforms, the reader may refer to the article by Gunilla Borgefors, entitled “Distance Transformation in digital images” published in 1986 in the journal Computer Vision, Graphics and Image Processing, Vol. 34, pp. 344-378.

In the field of navigation for moving objects, it is known to take prohibited or non-negotiable zones into account in the chamfer distance transforms, by assigning, authoratitively, an infinite distance to a point under analysis when it appears that it forms part of reliefs or obstacles to be negotiated that are listed in a memory of the zones to be negotiated, so as to eliminate, from the set of paths tested during a distance estimation, those that pass through the reliefs or obstacles that have to be negotiated. It is also known, from the aforementioned U.S. Patent Application US 2007031007, to take account, in the chamfer distance transforms, of the constraints associated with the progress of the moving object, while retaining, in the paths used for a distance estimation, only the paths that the moving object is capable of travelling while respecting its intrinsic constraints. In the exemplary embodiment given in this U.S. Patent Application US 2007031007, the only paths used for distance estimations are those that the aircraft is capable of travelling with, at any point, an altitude resulting from following a path with an imposed vertical profile, above the elevation of the terrain appearing in the terrain elevation database increased by a safety margin.

The most immediate way of taking into account weather effects in a metric obtained by applying a chamfer distance transform in the presence of constraints to a map of the relief taken from a terrain elevation database, consists in likening the weather effects to moving ground obstacles, but with the drawback of ignoring any possibility of negotiating them from below. This may be particularly penalizing when the weather effect occurs in the vicinity of a point of destination.

### SUMMARY OF THE INVENTION

An object of the present invention is to remedy the aforementioned drawback. More precisely, the subject of the invention is a metric giving, in a map obtained by projecting, on a horizontal plane, a representation of an flying space as elementary cubes associated with danger levels, an estimation of the distances taking into account the possible existence, beneath the elementary cubes of the representation of the flying space that are associated with high danger levels, of elementary cubes, with a low or non-existant danger level, which can be negotiated without any risk by the moving object.

The invention is directed to a method for estimating, for a moving object subject to vertical path profile and risk minimization constraints, the distances of the points on a map obtained by projection on a horizontal plane of a 3D representation of an flying space by a mesh of elementary cubes associated with danger levels and identified by an altitude, a latitude and a longitude. This method employs a distance transform operating by propagation on an image 2D of the map.

The image pixels or points are arranged in rows and columns by orders of longitude and latitude values. They correspond to the columns of elementary cubes of the mesh of the representation of the flying space and identify, for each column, prohibited altitudes corresponding to the cubes associated with danger levels above a value N, permissible for obviating them.

The distance transform estimates the distance of the various points of the image relative to a source point placed near the moving object by applying, by scanning, a chamfer mask at the various points of the image.

The estimation of the distance of a point, by applying the chamfer mask to this point, called the target point, being carried out by listing the various paths ranging from the target point to the source point and passing through points in the vicinity of the target point that are covered by the chamfer mask and the distances of which to the source point have been estimated beforehand during the same scan, by determining the length of the various listed paths by summing the distance assigned to the passage point in the vicinity and its distance to the target point extracted from the chamfer mask, by seeking the shortest path among the listed paths and by adopting its length as the estimate of the distance from the target point. Initially, at the start of scanning, a distance greater than the largest measurable distance on the image is attributed to all the points of the image apart from the source point, which is the origin of the distance measurements, to which a zero distance value is assigned. The lengths of the listed paths, during application of the chamfer mask at a target point, for the purpose of seeking the shortest path, being converted to travel time for the moving object and the listed paths, the travel times of which for the moving object are such that it would reach the target point in an elementary cube of the representation of the flying space, the danger level of which is above a permissible value, are excluded from the search for the shortest path.

Advantageously, when the moving object is an aircraft having a vertical flight profile to be respected, defining the evolution in its instantaneous altitude, the predictable values of the instantaneous altitudes that the aircraft would have by reaching the target point via the listed paths while respecting the imposed vertical flight profile are associated with the length of these paths and the listed paths associated with predictable values of altitude reached, which correspond to the aircraft passing through an elementary cube of the representation of the flying space, the danger level of which is above a permissible value for the continuation of the flight extended by a safety margin, are eliminated.

Advantageously, when the moving object is an aircraft having an imposed vertical flight profile, the estimation of the distance, carried out by propagation on the image consisting of the projection on a horizontal plane of the 3D representation of the air space corresponding to the map, is duplicated with an estimation of the predictable altitude of the aircraft in line with the various points of the image assuming that it follows the shortest selected distance estimate and that it respects the imposed vertical flight profile.

Advantageously, the chamfer distance transform scans the pixels of the image consisting of the projection on a horizontal plane of the 3D representation of the flying space in several successive passes in different orders.

Advantageously, the chamfer distance transform scans the pixels of the image consisting of the projection on a horizontal plane of the 3D representation of the flying space in several successive passes in different orders and repeatedly, until the distance estimates obtained stabilize.

Advantageously, the chamfer distance transform scans the pixels of the image consisting of the projection on a horizontal plane of the 3D representation of the flying space in several successive passes in different orders, including in lexicographic order, in reverse lexicographic order, in transposed lexicographic order and in reverse transposed lexicographic order.

Advantageously, the chamfer distance transform scans the pixels of the image consisting of the projection on a horizontal plane of the 3D representation of the flying space in a series of four passes, repeated until the distance estimates have stabilized, namely:
a first pass made row by row from the top of the image downwards, each row being travelled from left to right;
a second pass made row by row from the bottom of the image upwards, each row being travelled from right to left;
a third pass made column by column from the left to the right of the image, each column being travelled from the top downwards; and
a fourth pass made column by column from the right to the left of the image, each column being travelled from the bottom upwards.

Advantageously, the chamfer distance transform scans the pixels of the image consisting of the projection on a horizontal plane of the 3D representation of the flying space in a series of eight passes, repeated until the distance estimates have stabilized, namely:
a first pass made row by row from the top of the image downwards, each row being travelled from left to right;
a second pass made row by row from the bottom of the image upwards, each row being travelled from right to left;
a third pass made column by column from the left to the right of the image, each column being travelled from the top downwards;
a fourth pass made column by column from the right to the left of the image, each column being travelled from the bottom upwards;
a fifth pass made row by row from the top of the image downwards, each row being travelled from right to left;
a sixth pass made row by row from the bottom of the image upwards, each row being travelled from left to right;
a seventh pass made column by column from right to left of the image, each column being travelled from the top downwards; and
an eighth pass made column by column from left to right of the image, each column being travelled from the bottom upwards.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIGS. 1 and 2 illustrate, in vertical and horizontal sections, a scenario in which an aircraft is seeking to land in bad weather;

FIG. 3 shows an example of a chamfer mask;

FIGS. 4a and 4b show cells of the chamfer mask illustrated in FIG. 3, which are used in a scan pass in lexicographic order and in a scan pass in reverse lexicographic order;

FIG. 5 is a diagram illustrating the main steps of a method according to the invention of estimating the distance of a point taking into account the constraints when applying a chamfer mask;

FIG. 6 is a diagram illustrating an alternative form of the method of estimating the distance of a point shown in FIG. 5; and

FIG. 7 is a diagram of the main steps of a method, according to the invention, employing the methods of estimating the distance of a point that are shown in FIGS. 5 and 6.

### DETAILED DESCRIPTION OF PREFERRED EMBODIMENT

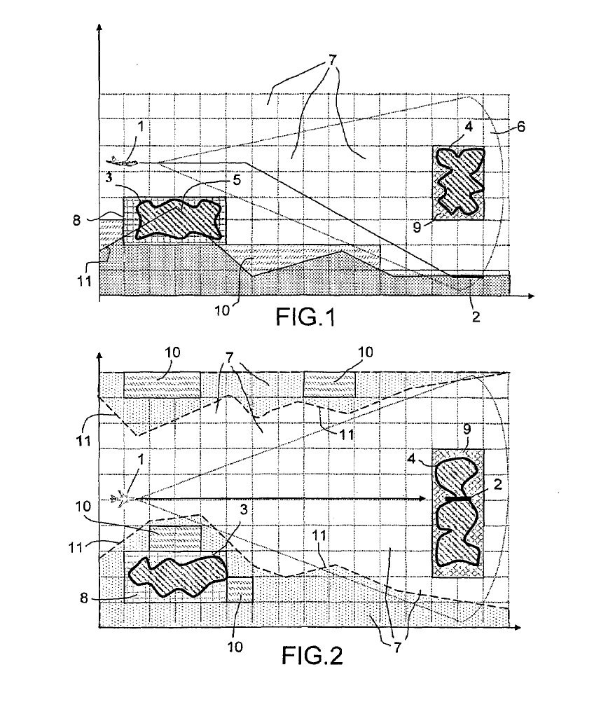

FIGS. 1 and 2 illustrate, in vertical section (FIG. 1) and in horizontal section (FIG. 2), a scenario in which an aircraft 1 is preparing to land in bad weather on a runway 2 surrounded by reliefs. The aircraft 1 is fitted with a weather radar and with a TAWS system for preventing collisions with the terrain, which displays, in the cockpit, a scrolling navigation map like the horizontal sectional view in FIG. 2, indicating, on a representation 11 of the relief taken from a terrain elevation database, the weather disturbances 3, 4 occurring in its vicinity and also the ground obstacles 5 that are dangerous for its navigation.

The weather radar of the aircraft takes moisture density measurements in the space 6 located in front of the aircraft, which it probes by sampling elementary volumes identified relative to the aircraft and then relative to geographical coordinates (latitude, longitude and altitude) corresponding to a mesh of elementary cubes 7 of the space through which the aircraft is flying. In the scenario shown in FIGS. 1 and 2, the weather radar, which has detected beforehand a disturbance 3 occurring laterally on a mountainous relief 5, is in the process of detecting a disturbance 4 occurring above the landing runway 2 where the aircraft 1 is intended to land. It brings these disturbances 3, 4 to the knowledge of the crew, by a special colouring of the navigation map, in the zones where the elementary cubes 8, 9 that they occupy are projected, this colouring appearing in the form of a specific texture in FIGS. 1 and 2.

The TAWS system displays the risks of collision with the terrain on the navigation map by special colouring of the elementary cubes 10 occupied by the reliefs, the heights of which are close to or above the current altitude of the aircraft 1. In FIG. 2, only the colouring used for the elementary cubes 10 occupied by reliefs that cannot be negotiated is evoked by having a particular texture.

The simple fact of displaying, on a scrolling navigation map, the zones which would be impossible or risky to negotiate does not allow an aircraft's crew to know if, taking into account a manoeuvre to avoid a risky zone and the flight performance of the aircraft, the next necessary point of passage of its flight plan or its destination terrain remains accessible. To do this, the navigation map has to be provided with a metric that takes into account not only the relief and the flight performance of the aircraft but also the particular features of the weather that may not descend down to ground level and which therefore can only very roughly be likened to obstacles moving on the ground. This is because, in the scenario represented, such a likening would make the landing runway appear as impractical, while it remains so, resulting in the not really justified rerouting to another airport often far from the destination airport.

One particular implementation of a chamfer distance transform on the image formed by the projection on a horizontal plane of the 3D representation, by elementary cubes, of the air space through which the aircraft is flying makes it possible to obtain a metric that ensures the weather is better taken into account.

It will be recalled that the distance between two points on a surface is the minimum length of all the possible paths on the surface starting from one of the points and ending at the other. In an image formed from pixels distributed in a regular mesh of rows, columns and diagonals, a chamfer distance transform estimates the distance of one pixel called the “target” pixel from a pixel called the “source” pixel by progressively constructing, starting from the pixel source, the shortest possible path along the mesh of pixels and ending at the target pixel, and by employing distances found for the pixels of the image that have already been analyzed and using a table called a chamfer mask that lists the distances between a pixel and its nearest neighbours.

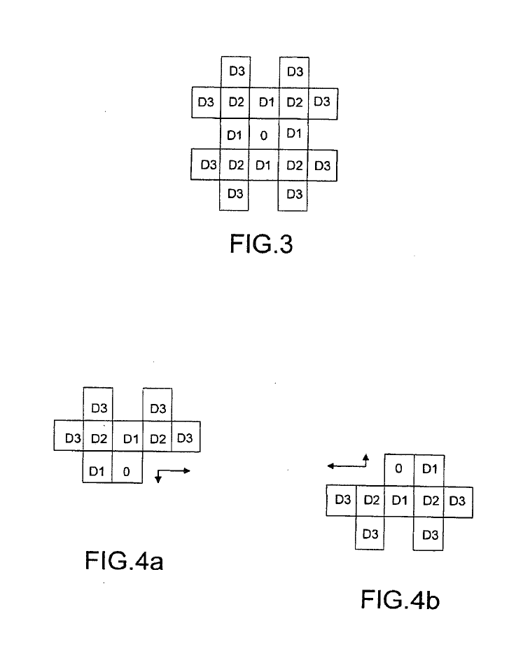

As shown in FIG. 3, a chamfer mask takes the form of a table with an arrangement of boxes reproducing the pattern of a pixel surrounded by its nearest neighbours. At the center of the pattern, a box assigned the value 0 identifies the pixel taken as the origin of the distances listed in the table. Clustered around this central box are peripheral boxes filled with nonzero proximity distance values, said boxes repeating the arrangement of the pixels in the neighbourhood of a pixel assumed to occupy the central box. The distance value appearing in a peripheral box is that of the distance separating a pixel occupying the position of the peripheral box in question from a pixel occupying the position of the central box. It should be noted that the proximity distance values are distributed in concentric circles. In a first circle, four boxes corresponding to the four pixels, which are the closest to the pixel of the central box, either in the same row or in the same column as the pixel of the central box, are assigned a distance value D1. In a second circle, four boxes corresponding to the four pixels, which are the closest to the pixel of the central box, outside the row and the column of the pixel of the central box, are assigned a distance value D2. In a third circle, eight boxes corresponding to the eight pixels, which are closest to the pixel of the central box, all remaining outside the row, column and diagonals that are occupied by the pixel of the central box, are assigned a proximity distance value D3.

The chamfer mask may cover a larger or smaller neighbourhood of the pixel of the central box, listing the distance values of a larger or smaller number of concentric circles of pixels in the neighbourhood. It may be reduced to the first two circles formed by the pixels in the neighbourhood of a pixel occupying the central box, or they may be extended beyond the first three circles formed by the pixels in the neighbourhood of the pixel of the central box. However, it is usual practice to stop at the first three circles, as in the case of the chamfer mask shown in FIG. 3. The distance values D1, D2 and D3, which correspond to Euclidean distances, are expressed on a scale which authorizes the use of integers at the cost of a certain approximation. Thus, G. Borgefors gives the value 5 to the distance D1, which corresponds to an x-axis or y-axis step and gives the value 7 to the distance D2, which corresponds to the square root of the sum of the squares of the x-axis and y-axis steps, namely \sqrt{x²+y²}, which value 7 is an approximation of 5\sqrt{2}, and gives the value 11, which is an approximation of 5\sqrt{5}, to the distance D3.

The progressive construction of the shortest possible path going to a target pixel, starting from a source pixel and following the mesh of the pixels, takes place by a regular scan of the pixels of the image by means of the chamfer mask. Initially, the pixels of the image are assigned an infinite distance value—in fact a sufficiently high number in order to exceed all the measurable distance values in the image—with the exception of the source pixel, which is assigned a zero distance value. Next, the initial distance values assigned to the target points are updated as the image is scanned by the chamfer mask, an update consisting in replacing a distance value assigned to a target point with a new, lower value resulting from a distance estimate made on the occasion of a new application of the chamfer mask to the target point in question.

A distance estimation, by applying the chamfer mask to a target pixel, consists in listing all the paths going from this target pixel to the source pixel and passing through a pixel in the neighbourhood of the target pixel, the distance of which has already been estimated during the same scan, in searching among the listing paths for the shortest path or paths, and in adopting the length of the shortest path or paths as the distance estimate. This is accomplished by placing the target pixel, the distance of which, in the central box of the chamfer mask, it is desired to estimate, by selecting the peripheral boxes of the chamfer mask that correspond to pixels in the neighbourhood, the distance of which has just been updated, by computing the lengths of the shortest paths connecting the target pixel to be updated to the pixel source passing through one of the selected pixels in the neighbourhood, by adding the distance value assigned to the pixel in the neighbourhood in question and the distance value given by the chamfer mask and in adopting as distance estimate, the minimum of the path length values obtained and of the old distance value assigned to the pixel over the course of the analysis.

The order in which the pixels of the image are scanned has an influence on the reliability of the distance estimates and of their updating since the paths taken into account depend thereon. In fact, the order is subject to a regularity constraint which means that, if the pixels of the image are listed in lexicographic order (pixels classified in an order increasing row by row starting from the top of the image and progressing towards the bottom of the image, and from left to right within one row), and if a pixel p has been analyzed before a pixel q, then a pixel p+x must be analyzed before the pixel q+x. The lexicographic order, the reverse lexicographic order (scanning of the pixels of the image row by row from the bottom upwards and, within a row, from right to left), the transposed lexicographic order (scanning of the pixels of the image column by column from left to right and, within a column, from the top downwards) and the reverse transposed lexicographic order (scanning of the pixels by columns from right to left and, within a column, from the bottom upwards) satisfy this regularity condition and, more generally, all scans in which the rows and columns are scanned from right to left or from left to right. G. Borgefors recommends scanning the pixels of the image twice, once in lexicographic order and once in reverse lexicographic order.

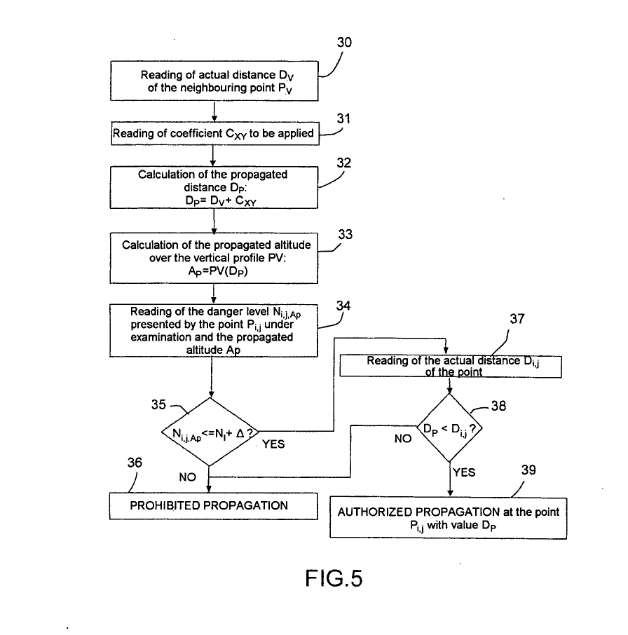

FIG. 4a shows, in the case of a scan pass in lexicographic order going from the upper left corner to the bottom right corner of the image, the boxes of the chamfer mask of FIG. 1 that are used to list the paths going from a target pixel placed in the central box (the box indexed by 0) to the source pixel passing through a pixel in the neighbourhood, the distance of which has already been estimated during the same scan. There are eight of these boxes, placed in the left upper part of the chamfer mask. There are therefore eight paths listed for the search for the shortest, the length of which is taken as the distance estimate.

FIG. 4b shows, in the case of a scan pass in reverse lexicographic order going from the right lower corner to the left upper corner of the image, the boxes of the chamfer mask of FIG. 1 that are used for listing the paths going from a target pixel placed in the central box (the box indexed by 0) to the source pixel passing through a pixel in the neighbourhood, the distance of which has already been estimated during the same scan. These boxes are complementary to the boxes of FIG. 2a. There are also eight of them based in the right lower part of the chamfer mask. Again, there are therefore eight paths listed for the search for the shortest, the length of which is taken as the estimate of the distance.

The chamfer distance transform, the principle of which has been briefly recalled, was designed originally for analyzing the position of objects in an image, but it has not delayed being applied to the estimation of the distances on a map of the relief extracted from a terrain elevation database with a regular mesh of the terrestrial surface. However, such a map does not explicitly use a metric since it is plotted on the basis of the altitudes of the points of the mesh of the terrain elevation database of the region represented. In this context, the chamfer distance transform is applied to an image in which the pixels are elements of the elevation database of the terrain belonging to the map, that is to say the altitude values associated with the latitude and longitude geographical coordinates of the nodes of the mesh where they have been measured, and classified, as on the map, by increasing or decreasing latitudes and longitudes according to a two-dimensional table of latitude and longitude coordinates.

For terrain navigation of moving objects, such as robots, the chamfer distance transform is used to estimate the distances of the points on the map of a moving terrain extracted from a terrain elevation database relative to the position of the moving object or a close position. In this case, it is known to take account of the areas on the map that cannot be negotiated by the moving object because of their abrupt configurations, by means of a marker showing the prohibited region associated with the elements of the terrain elevation database. This marker indicates, when it is activated, a prohibited or non-negotiable region, and inhibits any updating, other than initialization, of the distance estimation made by the chamfer distance transform for the pixal element in question.

In the case of an aircraft, the evolution in the non-negotiable regions as a function of the vertical profile imposed on the path of the aircraft is taken into account by means of the predictable altitude of the aircraft at each target point, the distance from which is in the process of being estimated. This predictable altitude, which obviously depends on the path followed, is that of the aircraft after following the adopted path for the distance measurement. The estimation of this predictable altitude of the aircraft at a target point is performed by propagation during the scanning of the image by the chamfer mask in a manner similar to the distance estimation. For each listed path going from a target point to a source point passing through a point in the vicinity of the target point, the distance from which to the source point and the predictable altitude of the aircraft have already been estimated during the same scan, the predictable altitude of the aircraft is deduced from the length of the path and of the vertical profile imposed on the path of the aircraft. This predictable altitude, estimated for each listed path going from a target point, the distance of which is in the process of being estimated to a source point placed in the vicinity of the position of the aircraft, is used as a criterion for selecting the paths taken into account in the distance estimation. If it corresponds, taking into account a safety margin, to an elementary cube representative of the air space, the level of danger of which is above the threshold required for the flight, that is to say if it corresponds to a prohibited altitude range because it lies in the relief or in a weather disturbance, then the listed path to which it is associated is discarded and does not contribute to the selection of the shortest path. Once the shortest path has been selected, its length is taken as the distance of a target point and the predictable altitude of the aircraft that is associated therewith is also adopted for the altitude of the aircraft at the target point.

FIG. 5 illustrates the main steps of the processing carried out when applying the chamfer mask to a target point P_{i,j} for estimating its distance for an aircraft having an imposed vertical path profile. The target point in question P_{i,j} is placed in the central box of the chamfer mask. For each neighbouring point P_{V} which enters the boxes of the chamfer mask and the distance of which has already been estimated during the same scan, the processing consists in:
reading the estimated distance D_{V} of the neighbouring point P_{V} (step 30);
reading the coefficient C_{XY} of the chamfer mask corresponding to the box occupied by the neighbouring point P_{V} (step 31);
calculating the propagated distance D_{P} corresponding to the sum of the estimated distance D_{V} of the neighbouring point P_{V} and of the coefficient C_{XY} assigned to that box of the chamfer mask which is occupied by the neighbouring point, P_{V}, namely:

D_{P}=D_{V}+C_{XY} (step 32),
calculating the predictable altitude A_{P} of the aircraft after negotiating the distance D_{P}, directly from the distance D_{P} if the vertical profile imposed on the path of the aircraft is defined according to the travelled distance PV(D_{P}) and implicitly takes into account the travel time, or indirectly via the travel time if the vertical profile imposed on the path of the aircraft is defined by an altitude change speed (step 33),
reading the predictable danger level N_{i,j,Ap} of the target point P_{i,j} in the representation in the form of elementary cubes of the air space at the predictable altitude A_{P} (step 34);
comparing the predictable danger level N_{i,j,Ap} with an authorized limit value Nₗ for the flight, increased by a safety margin Δ (step 35);
eliminating the propagated distance D_{P} if the predictable danger level N_{i,j,Ap} is above that permissible for the flight increased by the safety margin Δ (step 36);
if the predictable danger level N_{i,j,Ap,} increased by the safety margin Δ, is below the limit Nₗ set for the flight, reading the distance D_{i,j} already assigned to the target point in question P_{i,j} (step 37) and comparing it with the propagated distance D_{Pj} (step 38);
eliminating the propagated distance D_{P} if it is equal to or greater than the distance D_{i,j} already assigned to the point P_{i,j} in question (step 37), and comparing the propagated distance D_{Pj} (step 38);
eliminating the propagated distance D_{P} if it is equal to or greater than the distance D_{i,j} already assigned to the target point P_{i,j} in question; and
replacing the distance D_{i,j} already assigned to the target point P_{i,j} in question with the propagated distance D_{P} if the latter is shorter (step 39).

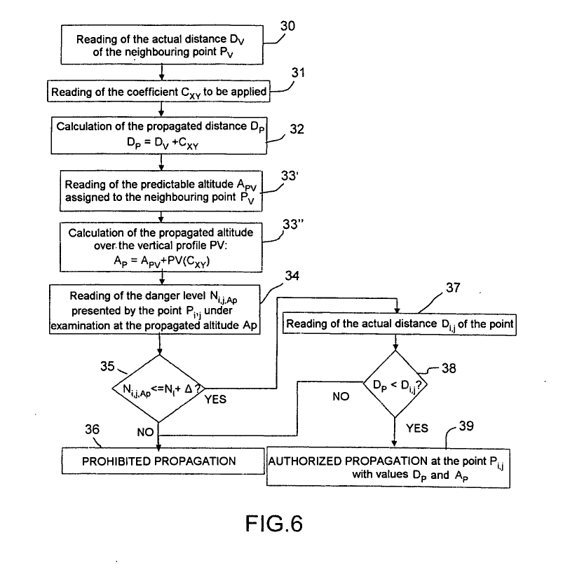

FIG. 6 illustrates the main steps of an alternative form of the processing carried out when applying the chamfer mask to a target point P_{i,j} in order to estimate its distance for an aircraft having an imposed vertical path profile.

This alternative form differs in the way in which the predictable altitude A_{P} of the aircraft is generated and assumes that the predictable altitude for the aircraft at each point in the terrain elevation database, calculated as a function of the vertical profile imposed on its path and on the basis of the length of the path selected for the distance measurement, is stored in the same way as the distance estimation. In this alternative form, the step (33) of calculating the predictable altitude A_{P} of the aircraft is divided into two steps: a step (33′) of reading the predictable altitude A_{PV} for the aircraft at the neighbouring point P_{V}, and a calculation step (33″) for calculating the predictable altitude A_{P} by summing the predictable altitude A_{PV} at the target point P_{V} and the change in altitude over the distance separating the neighbouring point P_{V} from the target point P_{i,j} due to the vertical profile imposed on the path of the aircraft.

As indicated previously, the distances of the various points on the map are estimated by applying a chamfer mask treatment such as those described above relating to FIGS. 5 and 6, to all of the pixels of the image formed by the elements of the elevation database of the terrain belonging to the map, taken in succession according to a regular scan comprising a minimum of two passes made in reverse orders.

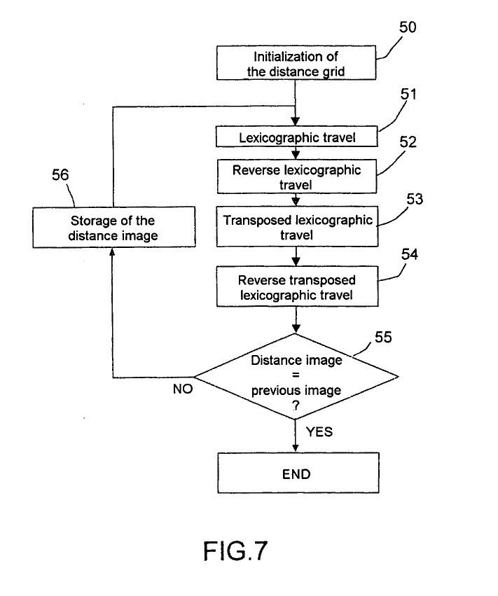

FIG. 7 illustrates the main steps of an example of an overall procedure for estimating the distances of all of the points of a relief map for a moving object subject to dynamic constraints.

The first step 50 of the procedure is to initialize the distances assigned to the various points of the map in question, such as the pixels of an image. This initialization of the distances consists, as indicated previously, in assigning an infinite distance or at the very least a distance greater than the largest measurable distance on the map, for all the points in question on the map, such as target points, with the exception of just one point considered as the source of all the distances to which a zero distance value is assigned. This source point is chosen to be close to the instantaneous position of the moving object on the map.

The next steps 51 to 54 are passes of a regular scan, during which the chamfer mask is applied in succession and with several repeats to all the points in question of the map, such as the pixels of an image, the application of the chamfer mask to a point on the map giving an estimation of the distance of this point to the source point, by carrying out one of the processing operations described in relation to FIG. 5 or FIG. 6.

The first scan pass (step 51) is performed in lexicographic order, the pixels of the image being analyzed row by row from the top down of the image and from left to right within the same row. The second scan pass (step 52) is performed in reverse lexicographic order, the pixels of the image again being analyzed row by row, but from the bottom up, of the image and from right to left within a row. The third scan pass (step 53) is performed in transposed lexicographic order, the pixels of the image being analyzed column by column from left to right of the image and from the top down within the same column. The fourth scan pass (step 54) is performed in reverse transposed lexicographic order, the pixels of the image being analyzed column by column, but from right to left, of the image and from the bottom up within the same column.

These four passes (steps 51 to 54) are repeated until the distance image obtained changes. To do this, the content of the distance image obtained is stored (step 56) after each series of four passes (steps 51 to 54) and compared with the content of the distance image obtained in a previous series (step 55), the loop being broken only when the comparison shows that the content of the distance image no longer varies.

In theory, two scan passes in lexicographic order and in reverse lexicographic order may suffice. However, the presence of prohibited passage regions of concave shape may cause, in the distance propagation, dead zones containing pixels for which the application of the chamfer mask does not give a distance estimation. To reduce this risk of a dead zone, it is necessary to vary the direction of the distance propagation by varying the direction of the scan, hence a doubling of the number of passes with a transposition of the scanning orders corresponding to a rotation of the image through 90°. For even better elimination of dead zones, a series of eight passes may be carried out:
a first pass made row by row from the top of the image downwards, each row being travelled from left to right;
a second pass made row by row from the bottom of the image upwards, each row being travelled from right to left;
a third pass made column by column from the left to the right of the image, each column being travelled from the top downwards;
a fourth pass made column by column from the right to the left of the image, each column being travelled from the bottom upwards;
a fifth pass made row by row from the top of the image downwards, each row being travelled from right to left;
a sixth pass made row by row from the bottom of the image upwards, each row being travelled from left to right;
a seventh pass made column by column from right to left of the image, each column being travelled from the top downwards; and
an eighth pass made column by column from left to right of the image, each column being travelled from the bottom upwards.

It will be readily seen by one of ordinary skill in the art that the present invention fulfills all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalent thereof.

1. Method for estimating for a moving object subject to path and risk minimization constraints, the distances of the points on a map obtained by projection on a horizontal plane of a 3D representation of a flying space by a mesh of elementary cubes associated with danger levels and identified by an altitude, a latitude and a longitude, said method comprising the steps of:
employing a chamfer distance transform operating by propagation on an image 2D of the map;
arranging pixels or points of said image being in rows and columns by orders of longitude and latitude values, corresponding to the columns of elementary cubes of the mesh of the representation of the flying space and identifying, for each column, prohibited altitudes corresponding to the cubes associated with danger levels above a value Nₗ permissible for obviating them;
estimating using said distance transform the distance of the various points of the image relative to a source point placed near the moving object by applying, by scanning, a chamfer mask at the various points of the image;
the estimation of the distance of a target point, by applying the chamfer mask to the target point, being carried out by listing the various paths ranging from the target point to the source point and passing through points in the vicinity of the target point that are covered by the chamfer mask and the distances of which to the source point have been estimated beforehand during the same scan, by determining the length of the various listed paths by summing the distance assigned to the passage point in the vicinity and its distance to the target point extracted from the chamfer mask, by seeking the shortest path among the listed paths and by adopting its length as the estimate of the distance from the target point; a distance greater than the largest measurable distance on the image being initially attributed, at the start of the scan, to all the points of the image apart from the source point, which is the origin of the distance measurements, to which a zero distance value is assigned; the lengths of the listed paths, during application of the chamfer mask at a target point, for the purpose of seeking the shortest path, being converted to travel time for the moving object and the listed paths, the travel times of which for the moving object are such that it would reach the target point in an elementary cube of the representation of the flying space, the danger level of which is above a permissible value, being excluded from the search for the shortest path.

2. The method according to claim 1, applied to an aircraft having an imposed vertical flight profile, wherein the predictable values of the instantaneous altitudes that the aircraft would have by reaching a target point via the various possible paths while respecting the imposed vertical flight profile are associated with the lengths of these paths and in that the paths associated with predictable values of altitude reached, which correspond to the aircraft passing through an elementary cube of the representation of the flying space, the danger level of which is above a permissible value for the continuation of the flight extended by a safety margin, are eliminated from the search for the shortest path.

3. The method according to claim 2, applied to an aircraft having an imposed vertical flight profile, wherein the estimation of the distance, carried out by propagation on the image consisting of the projection on a horizontal plane of the 3D representation of the flying space corresponding to the map, is duplicated with an estimation of the predictable altitude of the aircraft in line with the various points of the image assuming that it follows the shortest selected distance estimate and that it respects the imposed vertical flight profile.

4. The method according to claim 1, wherein characterized in that the chamfer distance transform scans the pixels of the image consisting of the projection on a horizontal plane of the 3D representation of the flying space in several successive passes in different orders.

5. The method according to claim 4, wherein the chamfer distance transform scans the pixels of the image consisting of the projection on a horizontal plane of the 3D representation of the flying space in several successive passes in different orders and repeatedly, until the distance estimates obtained stabilize.

6. The method according to claim 4, wherein the chamfer distance transform scans the pixels of the image consisting of the projection on a horizontal plane of the 3D representation of the flying space in several successive passes in different orders, including in lexicographic order, in reverse lexicographic order, in transposed lexicographic order and in reverse transposed lexicographic order.

7. The method according to claim 4, wherein the chamfer distance transform scans the pixels of the image consisting of the projection on a horizontal plane of the 3D representation of the flying space in a series of four passes, repeated until the distance estimates have stabilized, namely:
a first pass made row by row from the top of the image downwards, each row being travelled from left to right;
a second pass made row by row from the bottom of the image upwards, each row being travelled from right to left;
a third pass made column by column from the left to the right of the image, each column being travelled from the top downwards; and
a fourth pass made column by column from the right to the left of the image, each column being travelled from the bottom upwards.

8. The method according to claim 4, wherein the chamfer distance transform scans the pixels of the image consisting of the projection on a horizontal plane of the 3D representation of the flying space in a series of eight passes, repeated until the distance estimates have stabilized, namely:
a first pass made row by row from the top of the image downwards, each row being travelled from left to right;
a second pass made row by row from the bottom of the image upwards, each row being travelled from right to left;
a third pass made column by column from the left to the right of the image, each column being travelled from the top downwards;
a fourth pass made column by column from the right to the left of the image, each column being travelled from the bottom upwards;
a fifth pass made row by row from the top of the image downwards, each row being travelled from right to left;
a sixth pass made row by row from the bottom of the image upwards, each row being travelled from left to right;
a seventh pass made column by column from right to left of the image, each column being travelled from the top downwards; and
an eighth pass made column by column from left to right of the image, each column being travelled from the bottom upwards.
